(19) United States
(12) Patent Application Publication
(10) Pub. No.: US 2022/0309274 A1
(43) Pub. Date: Sep. 29, 2022

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Sawako UMEDA, Kanagawa (JP)

(73) Assignee: FUJIFILM Business Innovation Corp., Tokyo (JP)

(21) Appl. No.: 17/398,005

(22) Filed: Aug. 10, 2021

(30) Foreign Application Priority Data
Mar. 25, 2021 (JP) 2021-051348

(51) Int. Cl. G06K 9/00; G06K 9/32; G06K 9/72; H04N 1/00

(52) U.S. Cl. CPC G06K 9/00449; G06K 9/3233; G06K 9/72; H04N 1/00331; G06K 9/00463; G06K 2209/01

(57) ABSTRACT

An information processing apparatus includes a processor configured to: receive an input of a value of an item of an attribute from a user, the attribute being to be assigned to a form shown by an acquired first image; specify a region in which the value of the item is shown in the first image; generate a rule for extracting the value of the item by using at least one of an element at a predetermined distance from the specified region or coordinates of the region in the first image; and extract the value of the item from a form shown by an acquired second image by using the rule.

### CROSS-REFERENCE TO RELATED APPLICATIONS

This application is based on and claims priority under 35 USC 119 from Japanese Patent Application No. 2021-051348 filed Mar. 25, 2021.

### BACKGROUND

### (i) Technical Field

The present invention relates to an information processing apparatus, a non-transitory computer readable medium storing a program, and an information processing method.

### (ii) Related Art

The technique disclosed in JP2007-233913A includes an extraction item storage unit that stores extraction item information including an item name of an information item as an extraction target. Thus, a rule (extraction item information) for extracting an item value corresponding to the item name is required to be included, and the rule is required to be stored in advance in association with the item name.

The technique disclosed in JP2009-116488A includes a keyword storage unit that stores a keyword for creating index data used as an index of image data, in association with an attribute name of the index. Thus, a keyword used to extract attribute data from text data is required to be stored in advance in association with the attribute name.

### SUMMARY

An attribute may be assigned to a form. Such an attribute is configured by an item and a value for the item. One of techniques for assigning an attribute to a form is a technique for specifying an item of an attribute provided in the form, extracting information located around the specified item as a value for the item, and then assigning the extract information. In this case, it is necessary to define an item of an attribute intended to be specified, in advance.

Aspects of non-limiting embodiments of the present disclosure relate to an information processing apparatus, a non-transitory computer readable medium storing a program, and an information processing method that extract a value of an item without defining the item in advance, in a case where the value corresponding to the item of an attribute to be assigned to a form is extracted.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: receive an input of a value of an item of an attribute from a user, the attribute being to be assigned to a form shown by an acquired first image; specify a region in which the value of the item is shown in the first image; generate a rule for extracting the value of the item by using at least one of an element at a predetermined distance from the specified region or coordinates of the region in the first image; and extract the value of the item from a form shown by an acquired second image by using the rule.

### BRIEF DESCRIPTION OF THE DRAWINGS

Exemplary embodiment (s) of the present invention will be described in detail based on the following figures, wherein:

FIG. 1 is a diagram illustrating an example of an overall configuration of an information processing system 9;

FIG. 2 is a diagram illustrating an example of a configuration of an information processing apparatus 1;

FIG. 3 is a diagram illustrating an example of a default rule DB 121;

FIG. 4 is a diagram illustrating an example of a custom rule DB 122;

FIG. 5 is a diagram illustrating an example of a default item DB 123;

FIG. 6 is a diagram illustrating an example of a custom item DB 124;

FIG. 7 is a diagram illustrating an example of a form DB 125;

FIG. 8 is a diagram illustrating an example of a configuration of a terminal 2;

FIG. 9 is a diagram illustrating an example of a configuration of an image scanning device 4;

FIG. 10 is a diagram illustrating an example of a functional configuration of the information processing apparatus 1;

FIG. 11 is a flowchart illustrating an example of an operation flow of the information processing apparatus;

FIG. 12 is a diagram illustrating an example of a correction screen displayed on the terminal 2;

FIG. 13 is a diagram illustrating an example of a window W2;

FIG. 14 is a diagram illustrating an example of an image G displayed in the window W1;

FIG. 15 is a diagram illustrating a situation in which an erroneous custom rule is generated;

FIG. 16 is a diagram illustrating a manner of transmitting an inquiry for using the custom rule to a user;

FIG. 17 is a diagram illustrating an example in which a plurality of item values are displayed in a manner in accordance with an extraction frequency of the rule used in extraction;

FIG. 18 is a diagram illustrating an example of the information processing apparatus 1 that acquires an attribute name from an external device;

FIG. 19 is a diagram illustrating a cluster system 6C;

FIG. 20 is a diagram illustrating an example of a server device 6;

FIG. 21 is a diagram illustrating an example of an application DB 621;

FIG. 22 is a diagram illustrating an example of an operation of the information processing apparatus 1; and

FIG. 23 is a diagram illustrating an example of a selection screen.

### DETAILED DESCRIPTION

### Exemplary Embodiment

Configuration of Information Processing System

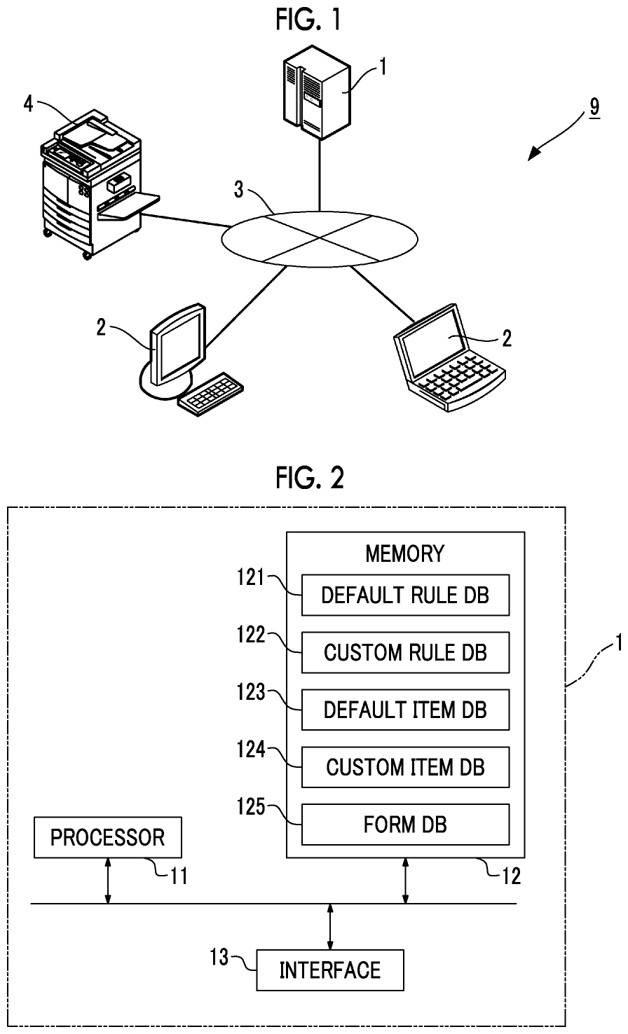

FIG. 1 is a diagram illustrating an example of an overall configuration of an information processing system 9. The information processing system 9 illustrated in FIG. 1 is a system that scans a form and assigns an attribute to the form. As illustrated in FIG. 1, the information processing system 9 includes an information processing apparatus 1, a terminal 2, a communication line 3, and an image scanning device 4.

The information processing apparatus 1 is an apparatus that extracts an attribute from an image showing a form and assigns the attribute to the form. The information processing apparatus 1 is, for example, a computer.

The terminal 2 is a terminal device operated by each user of the information processing system 9, and is, for example, a personal computer or the like.

The image scanning device 4 is, for example, a device that scans a document (such as a form) in which information is described on a medium such as paper, and outputs image data indicating the corresponding image.

The communication line 3 is a line for communicably connecting the information processing apparatus 1, the terminal 2, and the image scanning device 4 to each other. The communication line 3 may be, for example, a local area network (LAN), a wide area network (WAN), the Internet, or a combination thereof.

The numbers of the information processing apparatuses 1, the terminals 2, the communication lines 3, and the image scanning devices 4 in the information processing system 9 are not limited to the numbers illustrated in FIG. 1. For example, the information processing apparatus 1 may be configured by a cluster system in which a plurality of devices share functions.

Configuration of Information Processing Apparatus

FIG. 2 is a diagram illustrating an example of a configuration of the information processing apparatus 1. The information processing apparatus 1 illustrated in FIG. 2 includes a processor 11, a memory 12, and an interface 13. That is, the information processing apparatus 1 is an example of an information processing apparatus including a memory and a processor. The components are communicably connected to each other, for example by a bus.

The processor 11 reads and executes a program stored in the memory 12, and thereby controls the units of the information processing apparatus 1. The processor 11 is, for example, a central processing unit (CPU).

The interface 13 is a communication circuit that communicably connects the information processing apparatus 1 to the terminal 2 and the image scanning device 4 via the communication line 3 in a wired or wireless manner.

The memory 12 is a storage unit that stores an operating system, various programs, data, and the like read into the processor 11. The memory 12 includes a random access memory (RAM) and a read only memory (ROM). The memory 12 may include a solid state drive, a hard disk drive, or the like. The memory 12 stores a default rule DB 121, a custom rule DB 122, a default item DB 123, a custom item DB 124, and a form DB 125.

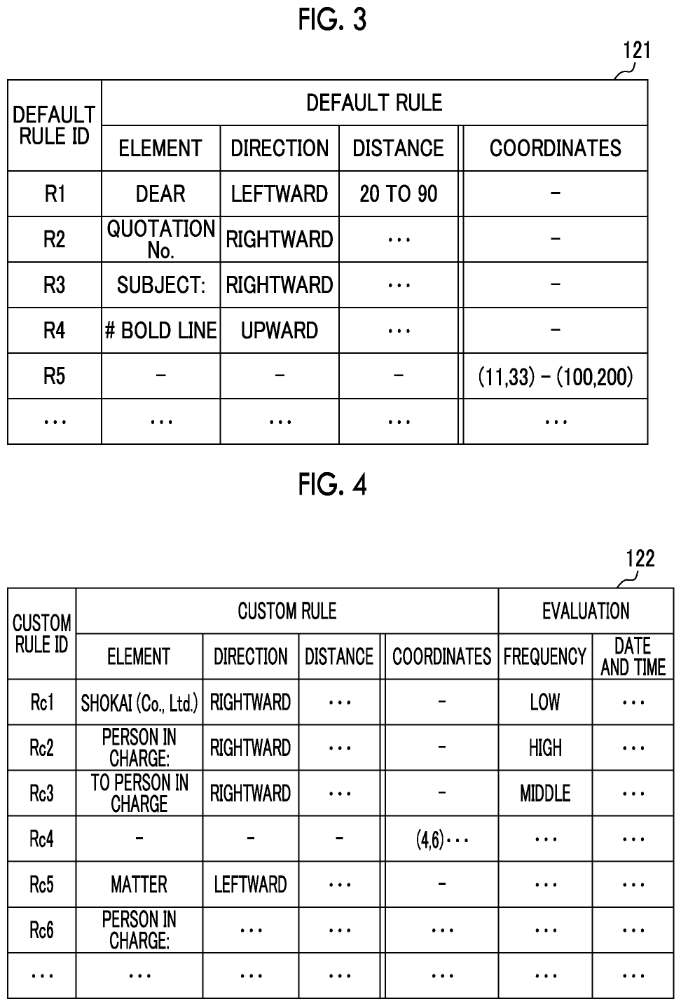

FIG. 3 is a diagram illustrating an example of the default rule DB 121. The default rule DB 121 illustrated in FIG. 3 is a database that stores a rule being default (referred to as a default rule) for specifying a region in which a value (also referred to as an item value) of an item of an attribute assigned to a form is shown. The default rule DB 121 is prepared in advance by the information processing apparatus 1. In the default rule DB 121 illustrated in FIG. 3, a default rule ID for identifying the default rule is associated with each default rule.

In the default rule DB 121 illustrated in FIG. 3, a rule for specifying the above region by using a relative position to various elements (such as a text string and a ruled line) included in a form is distinguished from a rule for specifying the above region by using an absolute position in the form with an upper left corner or the like as a reference point.

For example, a default rule identified by the default rule ID “R1” is a rule for specifying a region moved from the element “dear” to the “leftward” direction by a distance “20 to 90 (millimeters)”. For example, a default rule identified by the default rule ID “R4” is a rule for, in a case where the endpoint of the upper left corner is set to (0, 0), specifying a range surrounded by a rectangle in which the coordinates of the top left are set to (11, 33) and the coordinates of the bottom right are set to (100,200), as the above-described region. The default rule DB 121 illustrated in FIG. 3 exclusively adopts the default rule as either a relative rule or an absolute rule, but a rule obtained by combining the relative rule or the absolute rule may be adopted.

FIG. 4 is a diagram illustrating an example of the custom rule DB 122. The custom rule DB 122 is a database that stores a rule (referred to as a custom rule) added to specify a region which is not specified by the default rule. In the custom rule DB 122 illustrated in FIG. 4, a custom rule ID for identifying the custom rule is associated with each custom rule.

The custom rule DB 122 is common to the default rule DB 121 in that the custom rule DB stores the relative rule and the absolute rule. However, the custom rule DB 122 is different from the default rule DB 121 in that the custom rule DB stores a custom rule generated based on a correction instruction input in a case where a user assigns an attribute to a form.

In the custom rule DB 122 illustrated in FIG. 4, each custom rule is associated with the evaluation of each custom rule. The evaluation illustrated in FIG. 4 includes a frequency and the date and time. The frequency indicates a frequency (also referred to as an extraction frequency) at which the information processing apparatus 1 extracts the item value by using the custom rule within a predetermined period. The date and time indicate the date and time in which the custom rule has been last adopted.

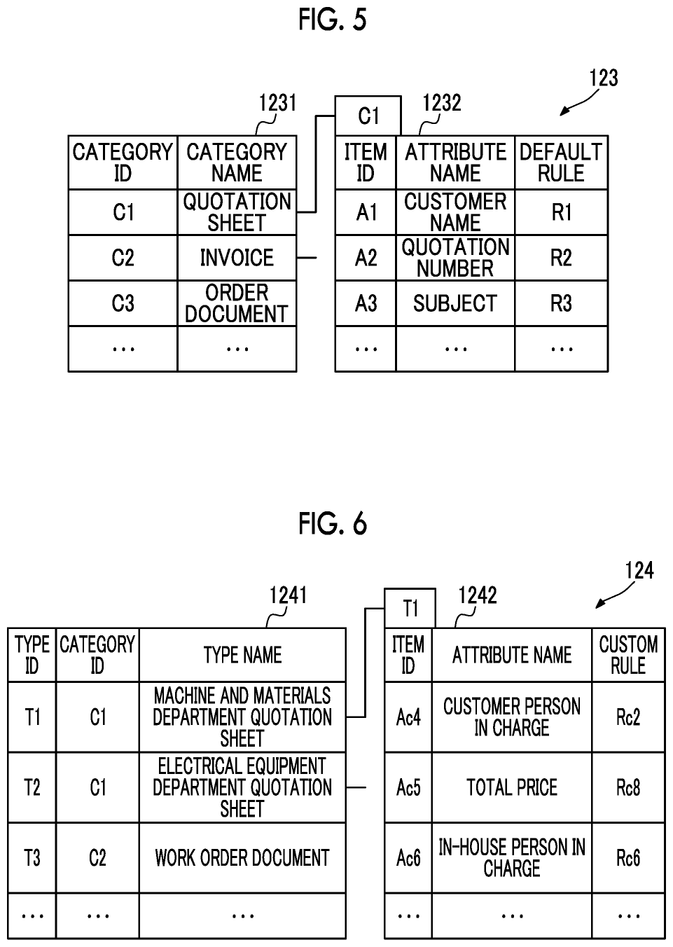

FIG. 5 is a diagram illustrating an example of the default item DB 123. The default item DB 123 is a database that stores the name (referred to as an attribute name) of an item of an attribute which is commonly assigned to the type of forms that belong to each category of the form. The default item DB 123 illustrated in FIG. 5 has a category list 1231 and an attribute name list 1232.

The category list 1231 is a list in which the name (referred to as a category name) of the category of the form and a category ID for identifying the category are listed in association with each other. The category is the classification destination in a case of classifying forms. The types of forms are defined, and the types belong to any category. For example, the type name “Machine and materials Department quotation sheet” and the type name “Electrical equipment Department quotation sheet” may have different paper sizes, different formats, different terminologies, and the like, but both are the type of form classified to an quotation sheet. Thus, the minimum items required for the quotation sheet are provided. Thus, the forms of the above-described type name belong to a common category with the category name “quotation sheet”.

The attribute name list 1232 is a list associated with any category ID described in the category list 1231. The attribute name list is a list in which at least the attribute name indicating an attribute required to be assigned to a form of the type belonging to the category identified by the category ID is listed. In the attribute name list 1232 illustrated in FIG. 5, an item ID for identifying an item of an attribute, an attribute name indicating the attribute, and a default rule for specifying a region in which an item value of the attribute is shown in a case where this attribute is assigned are stored in association with each other.

FIG. 6 is a diagram illustrating an example of the custom item DB 124. The custom item DB 124 is a database that stores a category to which each type of form belongs and an attribute name indicating an attribute required to be additionally assigned to this type of form. The custom item DB 124 illustrated in FIG. 6 has a type list 1241 and an attribute name list 1242.

The type list 1241 is a list in which a type ID for identifying the type of form and the category ID for identifying the category to which the type belongs are listed in association with each other. In the type list 1241 illustrated in FIG. 6, each type ID is associated with the name (referred to as a type name) of the type identified by this type ID.

The attribute name list 1242 is a list associated with any type ID described in the type list 1241. The attribute name list 1242 is a list in which an attribute name that indicates an attribute required to be assigned to a form of the type identified by the type ID and is required to be defined in addition to the attribute name defined in the default item DB 123 is listed. In the attribute name list 1242 illustrated in FIG. 6, an item ID for identifying an item of an attribute, an attribute name indicating the attribute, and a custom rule for specifying a region in which an item value of the attribute is shown in a case where this attribute is assigned are stored in association with each other.

As illustrated in FIG. 6, a plurality of custom rules may be defined for the item ID. In a case where a plurality of custom rules are defined for one item ID, the item value approved by the user is adopted from values extracted by using the custom rules.

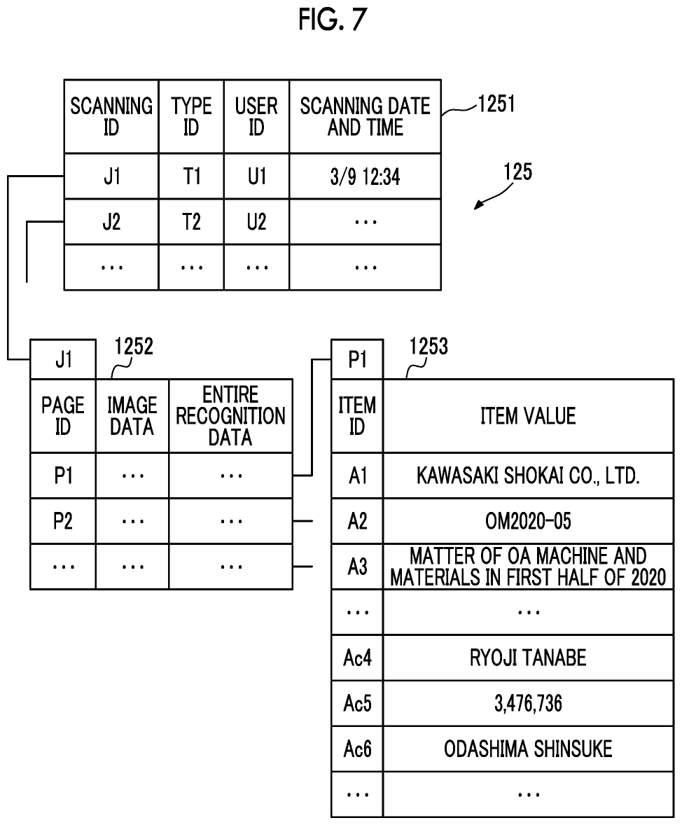

FIG. 7 is a diagram illustrating an example of the form DB 125. The form DB 125 is a database that, in a case where the user designates the type of form for a bundle of one or more forms and causes the image scanning device 4 to scan the forms, stores an attribute assigned to each of the scanned forms.

The form DB 125 illustrated in FIG. 7 has a scanning process list 1251, a form page list 1252, and an item value list 1253. The scanning process list 1251 is a list in which a process (referred to as a scanning process) in which the image scanning device 4 scans a bundle of forms is listed. In the scanning process list 1251, a scanning ID is identification information for identifying one scanning process. The type ID is identification information of the type of the form scanned by the scanning process. The user ID is identification information of the user who performs the scanning process. The scanning date and time is information indicating the date and time in which the scanning process is performed.

The form page list 1252 is a list in which image data of a form scanned by the scanning process identified by each scanning ID described in the scanning process list 1251, and data (referred to as entire recognition data) recognized by performing optical text recognition on the entirety of the image data are stored for each page of the form. The page ID is identification information for identifying the page of the form, and is, for example, a number.

The item value list 1253 is a list in which the item value of an attribute assigned to a page of a form, which is identified by each page ID described in the form page list 1252, is stored. In the item value list 1253 illustrated in FIG. 7, the item ID is identification information for identifying the item of the attribute assigned to the page of the above-described form, and the item value is the value of the item.

Configuration of Terminal

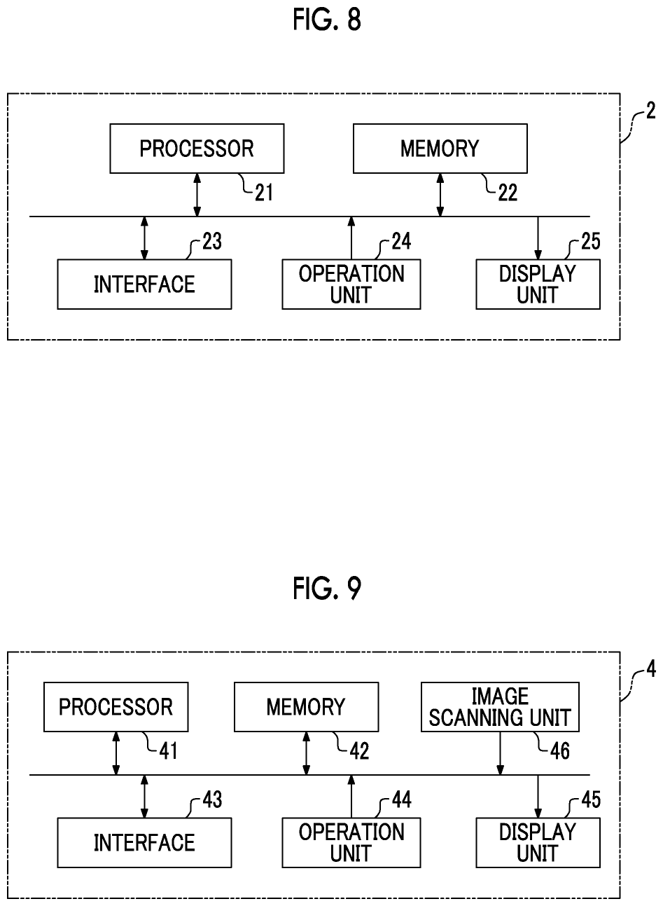

FIG. 8 is a diagram illustrating an example of a configuration of the terminal 2. The terminal 2 illustrated in FIG. 8 includes a processor 21, a memory 22, an interface 23, an operation unit 24, and a display unit 25. The components are communicably connected to each other, for example by a bus.

The processor 21 reads and executes a program stored in the memory 22, and thereby controls the units of the terminal 2. The processor 21 is, for example, a CPU.

The interface 23 is a communication circuit that communicably connects the information processing apparatus 1 and the image scanning device 4 with the terminal 2 via the communication line 3 in a wired or wireless manner.

The operation unit 24 includes an operation tool for issuing various instructions, such as operation buttons, a keyboard, a touch panel, and a mouse. The operation unit receives an operation and transmits a signal corresponding to the operation content to the processor 21.

The display unit 25 has a display screen such as a liquid crystal display, and displays an image under the control of the processor 21. A transparent touch panel of the operation unit 24 may be superposed on the display screen.

The memory 22 is a storage unit that stores an operating system, various programs, data, and the like read into the processor 21. The memory 22 includes a RAM and a ROM. The memory 22 may include a solid state drive, a hard disk drive, or the like.

Configuration of Image Scanning Device

FIG. 9 is a diagram illustrating an example of a configuration of the image scanning device 4. The image scanning device 4 illustrated in FIG. 9 includes a processor 41, a memory 42, an interface 43, an operation unit 44, a display unit 45, and an image scanning unit 46. The components are communicably connected to each other, for example by a bus.

The processor 41 reads and executes a program stored in the memory 42, and thereby controls the units of the image scanning device 4. The processor 41 is, for example, a CPU.

The interface 43 is a communication circuit that communicably connects the information processing apparatus 1 and the terminal 2 with the image scanning device 4 via the communication line 3 in a wired or wireless manner.

The operation unit 44 includes an operation tool for issuing various instructions, such as operation buttons and a touch panel. The operation unit receives an operation and transmits a signal corresponding to the operation content to the processor 41.

The display unit 45 has a display screen such as a liquid crystal display, and displays an image under the control of the processor 41. A transparent touch panel of the operation unit 44 may be superposed on the display screen.

The memory 42 is a storage unit that stores an operating system, various programs, data, and the like read into the processor 41. The memory 42 includes a RAM and a ROM. The memory 42 may include a solid state drive, a hard disk drive, or the like.

The image scanning unit 46 includes platen glass, an irradiation device that irradiates a medium with light, an optical system that collects reflected light, an image sensor device such as a complementary metal oxide semiconductor (CMOS) image sensor or a charge coupled device (CCD) image sensor, and the like. The image scanning unit 16 scans an image formed on a form placed on platen glass, generates image data indicating the scanned image, and supplies the generated image data to the processor 41, under control of the processor 41. The form is an object that transfers information by forming text and the like on a medium such as paper. The image scanning unit 46 may include an automatic document feeder (ADF) that transports a form page by page.

Functional Configuration of Information Processing Apparatus

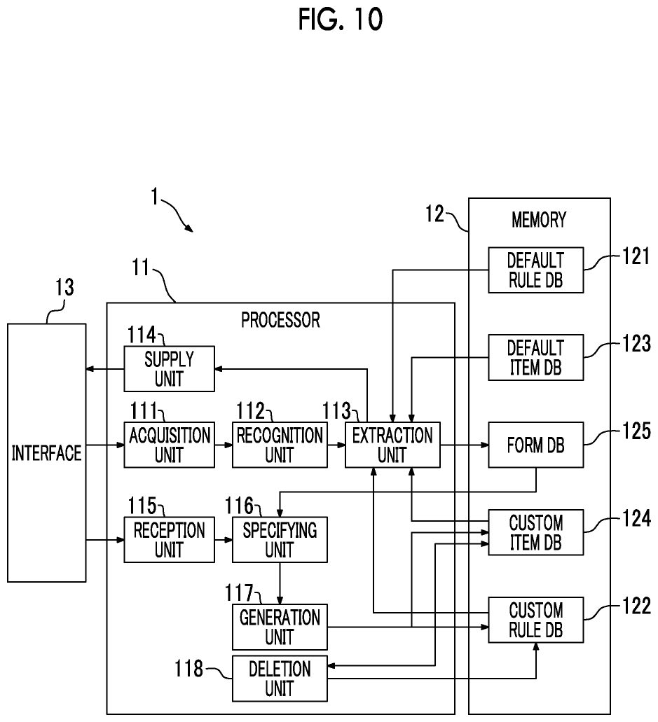

FIG. 10 is a diagram illustrating an example of a functional configuration of the information processing apparatus 1. The processor 11 of the information processing apparatus 1 executes a program stored in the memory 12 to function as an acquisition unit 111, a recognition unit 112, an extraction unit 113, a supply unit 114, a reception unit 115, a specifying unit 116, and a generation unit 117. As illustrated in FIG. 10, the processor 11 of the information processing apparatus 1 may function as a deletion unit 118.

The acquisition unit 111 acquires image data indicating an image of a form scanned by the image scanning device 4 and the type of the form, which is designated by the user.

The recognition unit 112 performs an optical text recognition process on the image data acquired by the acquisition unit 111 to recognize the text described in the form.

The extraction unit 113 extracts an item value of an attribute assigned to the form by using the default rule which is designated in the default item DB 123 and is stored in the default rule DB 121 or the custom rule which is designated in the custom item DB 124 and is stored in the custom rule DB 122. The extraction unit 113 stores the item value extracted for each page of the form in the form DB 125 in association with the item ID.

Thus, the processor 11 functioning as the extraction unit 113 is an example of a processor that extracts, from a form, the value of an item of an attribute assigned to the form by using a custom rule.

The custom item DB 124 illustrated in FIG. 6 has the attribute name list 1242 for each type ID. Thus, the extraction unit 113 described above specifies a list of an attribute name of an attribute required to be assigned to a form and extracts an item value corresponding to the attribute name, for each type of form. Thus, the processor 11 functioning as the extraction unit 113 is an example of a processor that extracts the value of an item from a form shown by an image for each type of image.

The supply unit 114 transmits the item value extracted by the extraction unit 113 to the terminal 2 and displays the item value on a correction screen. The correction screen is a screen for receiving an instruction of a user who corrects the content of the attribute assigned to the scanned form.

The reception unit 115 receives an input of the item value by the user on the correction screen displayed on the terminal 2. In a case where the user inputs an item value in order to create a new item, the reception unit 115 may receive an input of the name (also referred to as the item name or the attribute name) of the item in addition to the item value.

The specifying unit 116 specifies a region in which the item value received by the reception unit 115 is shown in the above-described image (also referred to as a first image) of the form to be corrected. For example, the specifying unit 116 searches for the received item value from the entire recognition data generated by the optical text recognition performed on the entire region of the image data indicating the image of the form. The specifying unit 116 obtains the position of the found item value in the first image and specifies the above-described region.

Therefore, the processor 11 functioning as the reception unit 115 is an example of a processor that receives, from the user, the input of the value of an item of an attribute assigned to a form indicated by the acquired first image.

The processor 11 functioning as the specifying unit 116 is an example of a processor that specifies a region in which the value of an item of an attribute is shown in the first image.

The generation unit 117 generates a rule for extracting the region specified by the specifying unit 116 from the image of the form. For example, the generation unit 117 searches for an element such as a text string or a ruled line drawn around the region specified by the specifying unit 116 in the first image. The generation unit specifies a distance and a direction from the searched region to the corresponding element, and generates a rule (that is, custom rule) using the specified distance and direction.

The generation unit 117 generates a custom rule using the coordinates of this region in the first image, for example, in a case where an element is not found around the region specified by the specifying unit 116.

Therefore, the processor 11 functioning as the generation unit 117 is an example of a processor that generates a rule for extracting the value of an item of an attribute to be assigned to a form, by using at least one of an element at a predetermined distance from the specified region or the coordinates of this region in the first image.

The generation unit 117 stores the generated custom rule in the custom rule DB 122. The generation unit 117 stores, in the custom item DB 124, the attribute name of an attribute assigned to a form in accordance with the item value received by the reception unit 115 and a custom rule ID for identifying the generated custom rule in association with each other.

For example, in a case where the input item value is a text string of “Ryoji Tanabe”, the generation unit 117 searches for an image around a region in which “Ryoji Tanabe” is described, in the form to find an element such as a text string and a ruled line. In a case where there is a text string of “person in charge:” in a range of 10 mm to 30 mm on the left side of “Ryoji Tanabe”, the generation unit generates a custom rule based on the found item. In this case, the custom rule is generated in a manner that three parameters of the element “person in charge:”, the direction “rightward”, and the distance “10 to 30 (millimeters)” are written in the custom rule DB 122 in association with the custom rule ID.

In a case where a text string of “customer person in charge” is input as a new attribute name together with the above-described “Ryoji Tanabe”, the generation unit 117 adds a record having this attribute name to the attribute name list 1242 corresponding to the type designated for the above-described form in the type list 1241 of the custom item DB 124. The generation unit 117 writes a custom rule ID indicating the generated custom rule in the field of the custom rule corresponding to this attribute name.

The deletion unit 118 illustrated in FIG. 10 deletes the custom rule from the memory 12 in a case where a condition determined for the custom rule is satisfied. For example, in a case where the condition is satisfied, the deletion unit 118 deletes the custom rule stored in the custom rule DB 122, and deletes the custom rule ID for identifying the custom rule, which is stored in the custom item DB 124.

The deletion here includes deleting a custom rule or a custom rule ID from the memory 12, but also includes, for example, linking the custom rule with a flag indicating that the use is prohibited. In short, the deletion here means a process of disabling a target custom rule.

The determined condition in this case is, for example, a case where the evaluation of the custom rule falls below the criterion. That is, for example, in a case where the extraction frequency using the custom rule is less than a threshold value for a predetermined period, or in a case where a period from a time at which the custom rule is last adopted is equal to or greater than a threshold value, the deletion unit 118 illustrated in FIG. 10 detects the custom rule.

Therefore, in a case where the processor functions as the deletion unit 118, the processor 11 is an example of a processor that deletes a rule in which the extraction frequency of the value of an item of an attribute is less than the threshold value for a predetermined period.

Operation of Information Processing Apparatus

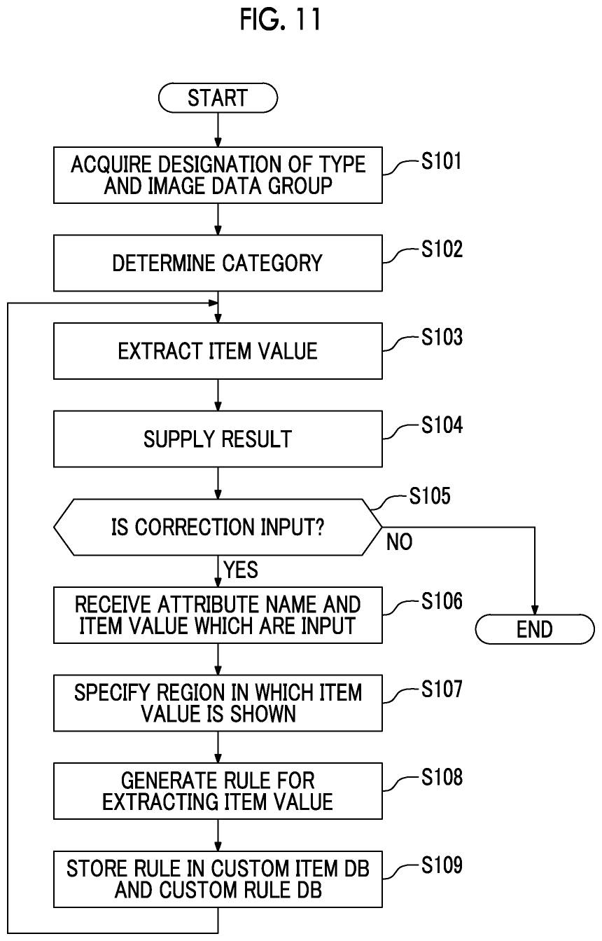

FIG. 11 is a flowchart illustrating an example of an operation flow of the information processing apparatus. The processor 11 of the information processing apparatus 1 acquires the designation of a type by the user and image data group corresponding to a bundle of the scanned forms, from the image scanning device 4 via the interface 13 (Step S101). The processor 11 determines the category to which the type of the form belongs (Step S102).

The category determination is performed, for example, by evaluating the similarity between the type name indicating the designated type and the category name stored in the default item DB 123. Specifically, the type name “machine and materials department quotation sheet” includes the category name “quotation sheet”. Thus, the processor 11 determines that both are similar. As a result, the processor 11 determines that the type indicated by the type name “machine and materials department quotation sheet” belongs to the category indicated by the category name “quotation sheet”, and determines the category. The similarity determination between the type name and the category name may be performed by, for example, the Levenshtein distance, or may be performed in a manner that the type name and the category name are vector-expressed by using a corpus.

The processor 11 extracts the item value (Step S103) and supplies the result of the extraction to the terminal 2 (Step S104).

The terminal 2 that receives the result of the extraction from the information processing apparatus 1 displays the contents on the display unit 25, and also receives the input of the correction by the user from the operation unit 24. In a case where the terminal receives the input of the correction, the terminal 2 transmits the input contents to the information processing apparatus 1.

The processor 11 determines whether or not the correction has been input by the user (Step S105). In a case where it is determined that the correction is not input (Step S105; NO), the processor 11 ends the process.

In a case where it is determined that the correction is input (Step S105; YES), the processor 11 receives the attribute name and the item value, which are input (Step S106).

The processor 11 specifies a region in which the received item value is shown in an image of the corrected form, that is, the first image (Step S107). Then, the processor generates a rule (that is, custom rule) for extracting the item value by using the specified region is generated (Step S108).

The processor 11 that generates the custom rule in Step S108 stores the generated custom rule and the custom rule ID in the custom item DB 124 and the custom rule DB 122, respectively (Step S109), and returns the process to Step S103.

Thus, the processor 11 extracts the item value by using the custom item DB 124 and the custom rule DB 122 that are changed in accordance with the correction of the form. The extraction of the item value is performed not only for the image (that is, the first image) of the form of which the correction is input, but also for images (also referred to as second image) of other forms having the same type.

### Operation Example

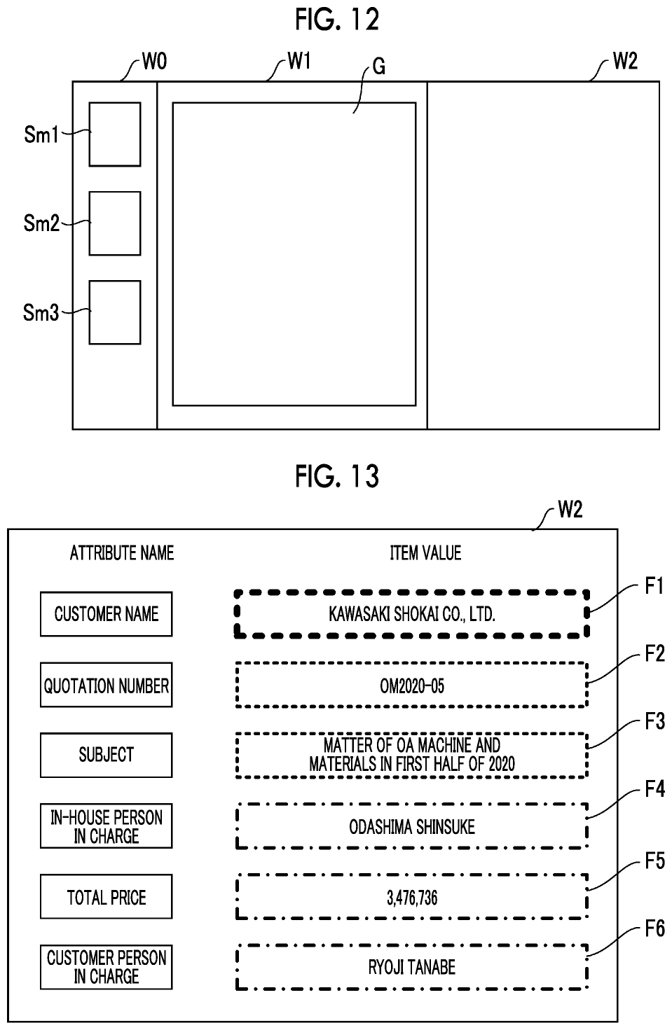

FIG. 12 is a diagram illustrating an example of the correction screen displayed on the terminal 2. As illustrated in FIG. 12, the correction screen has a configuration in which windows W0, W1, and W2 are arranged.

The window W0 illustrated in FIG. 12 is a window for displaying reduced images (also referred to as thumbnail images) showing the respective pages of the form, to be arranged in a vertical direction in the order of the pages. The thumbnail images are displayed, for example, so as to be in the selected state by the user hovering over the mouse pointer or the like and clicking or the like.

The window W1 illustrated in FIG. 12 is a window for displaying an image G of a form corresponding to the thumbnail image selected in the window W0.

The window W2 illustrated in FIG. 12 is a window for displaying the attribute extracted from the form indicated by the image G displayed in the window W1, in a form allowing correction. One attribute is configured by a set of an item and the value of the item. The window W2 is disposed, for example, on the left or right in association with a form for inputting the attribute name being the name of the item of the attribute and the item value being the value of the item.

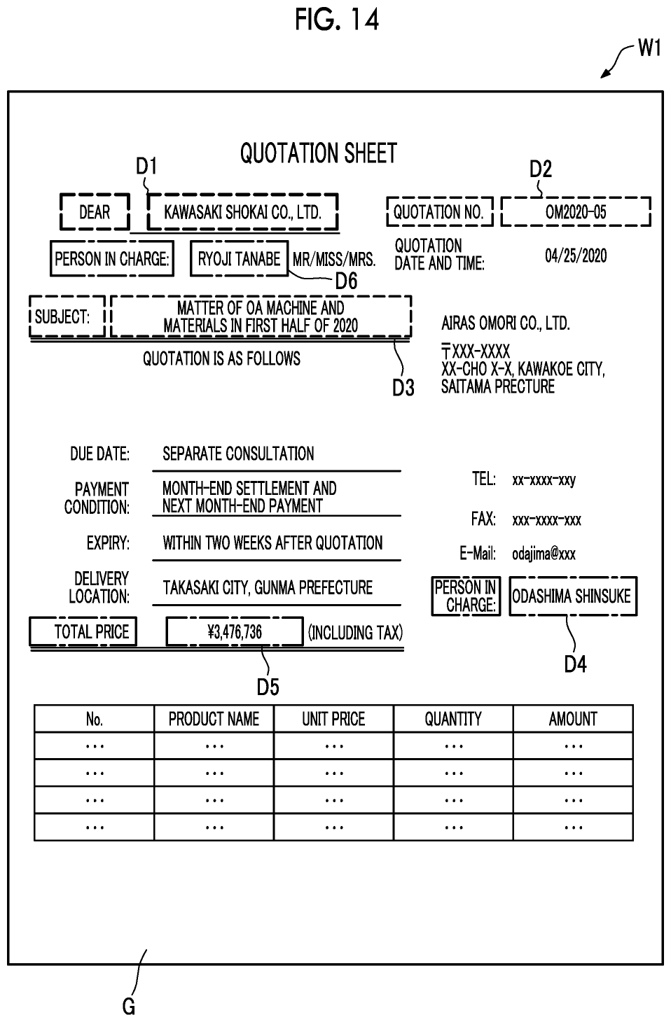

FIG. 13 is a diagram illustrating an example of the window W2. FIG. 14 is a diagram illustrating an example of the image G displayed in the window W1.

For example, a user identified by the user ID “U1” issues an instruction to perform the scanning process on a bundle of forms including a form illustrated in FIG. 14 with the image scanning device 4 at 12:34 on March 9. In addition, the user designates the type name of this form to “machine and materials department quotation sheet”. The image scanning device 4 transmits the designated type name and image data group of the scanned forms to the information processing apparatus 1. In addition to such transmission, the image scanning device 4 transmits the user ID “U1” for identifying the user who issues the instruction to perform the scanning process of an image and the scanning date and time “3/9 12:34” being information of the date and time at which the scanning is performed to the information processing apparatus 1.

In a case where the information processing apparatus acquires the designation of the type name and the image data group, the information processing apparatus 1 confirms whether or not the designated type name has been registered in the custom item DB 124. In an initial state, nothing is stored in the custom item DB 124. Thus, the information processing apparatus 1 adds the designated type name “machine and materials department quotation sheet” to the field of the type name in the type list 1241 and stores the designated type name in association with a new type ID “T1”.

The information processing apparatus 1 generates a new scanning ID “J1”, adds the generated scanning ID to the scanning process list 1251 in the form DB 125, and stores the generated scanning ID in association with the above-described type ID “T1”, the acquired user ID “U1”, and the scanning date and time “3/9 12:34”. Further, the information processing apparatus 1 associates each piece of the image data included in the acquired image data group with the page ID and stores the resultant of the association in the form page list 1252 of the form DB 125. The information processing apparatus 1 stores the image data and the entire recognition data obtained from the image data by the optical text recognition, in the form page list 1252 in association with each other.

The information processing apparatus 1 searches the category name similar to the designated type name “machine and materials department quotation sheet”, from the category list 1231 in the default item DB 123. In this case, since the category name “quotation sheet” is included in the type name “machine and materials department quotation sheet”, the information processing apparatus 1 determines that the category name is similar to the designated type name. The information processing apparatus 1 determines the category to which the type of the form having the type name “machine and materials department quotation sheet” belongs, to the category called by the category name “quotation sheet”. Then, the information processing apparatus associates the category ID “C1” with the type ID “T1” in the type list 1241.

Then, the information processing apparatus 1 extracts the item of an attribute assigned to the form of the type ID “T1”, from the default item DB 123 and the custom item DB 124. At this time, only the type ID “T1” is registered in the custom item DB 124, and the content of the attribute name list 1242, which corresponds to the type ID “T1” is empty. Therefore, the information processing apparatus 1 acquires the attribute name list 1232 of the category ID “C1” associated with the type ID “T1”, from the default item DB 123. Then, the information processing apparatus uses the default rule listed in the attribute name list 1232 to specify a region in which the item value of the attribute called by the corresponding attribute name is shown in the image of the form.

In a case where the default item DB 123 illustrated in FIG. 5 is stored in the memory 12 of the information processing apparatus 1, the information processing apparatus 1 uses the default rules identified by the default rule IDs “R1”, “R2”, and “R3” to specify regions in which the item values of the attributes called by the attribute names “customer name”, “quotation number”, and “subject” are shown, respectively. The regions are a region D1, a region D2, and a region D3 in FIG. 14.

For example, as illustrated in FIG. 3, the element “dear” and the direction “leftward” are associated with the default rule identified by the default rule ID “R1”. Therefore, the information processing apparatus 1 specifies the region D1 on the left side of the region in which the element “dear” is described in FIG. 14. The region D1 is a region in which the item value of the attribute called by the attribute name “customer name” is shown. The information processing apparatus 1 extracts the item value “Kawasaki Shokai Co., Ltd.” from this region by the optical text recognition.

The information processing apparatus 1 also performs the optical text recognition for the regions D2 and D3 and extracts the item value “0M2020-05” and the item value “matter of OA equipment in the first half of 2020”, respectively.

The information processing apparatus 1 causes the terminal 2 to display the regions in a common manner so that the user is informed that all the regions D1, D2, and D3 are specified by the default rules. For example, as illustrated in FIG. 14, the regions D1, D2, and D3 are surrounded by a common broken line. The regions specified by the default rules may be surrounded by a line of a common color such as blue.

At this stage, in the window W2 illustrated in FIG. 13, item values are described only in forms F1, F2, and F3. As a correction instruction, the user inputs, for example, the text string “Odashima Shinsuke” in the blank form F4, as illustrated in FIG. 13, and also inputs the text string “in-house person in charge” as the corresponding attribute name. The terminal 2 transmits the correction instruction to the information processing apparatus 1.

The information processing apparatus 1 searches for the input “Odashima Shinsuke” from the entire recognition data of the image G, and specifies the region D4 illustrated in FIG. 14 as the region corresponding to the input. The information processing apparatus 1 searches for the image around the region D4 and generates a custom rule.

In this case, the text string “person in charge:” is described on the left side of the region D4. Therefore, the information processing apparatus 1 specifies the “person in charge:” as an element, and generates a custom rule indicating that there is a region in which the item value is shown, on the right side of the element “person in charge:”.

The user also inputs the text strings “3,476,736” and “Ryoji Tanabe” as correction instructions for the forms F5 and F6, respectively, as illustrated in FIG. 13. In addition, the user inputs the text strings “total price” and “customer person in charge” as the attribute names corresponding to the respective input text strings. The terminal 2 transmits the correction instructions to the information processing apparatus 1.

The information processing apparatus 1 searches for the input in the correction instructions from the entire recognition data and specifies the regions D5 and D6 illustrated in FIG. 14, as the corresponding regions. The information processing apparatus 1 generates a custom rule based on each of the regions. The information processing apparatus 1 stores the generated custom rule in the custom rule DB 122. The information processing apparatus 1 stores the custom rule ID for identifying the generated custom rule and the input attribute name in association with the attribute name list 1242 of the custom item DB 124. In a case where the input attribute name is not registered yet, the information processing apparatus 1 generates a new item ID, and stores the generated item ID in the attribute name list 1242 of the custom item DB 124, in association with the custom rule ID and the attribute name described above.

In a case where the information processing apparatus 1 generates a custom rule and updates the custom rule DB 122 and the custom item DB 124 based on the generated custom rule, the information processing apparatus 1 uses the custom rule DB and the custom item DB to extract the item value of the attribute assigned to the form again. At this stage, the custom rule DB 122 stores the custom rule generated in response to the correction instruction input by the user, and an item for which the item value is extracted by using the custom rule is defined in the custom item DB 124. Therefore, the information processing apparatus 1 can extract the item value input by the user from the form as a target of the correction instruction, by the generated custom rule. The information processing apparatus 1 can extract the item value corresponding to the attribute name input by the user, by using the custom rule for a form different from the form as the target of the correction instruction, among a plurality of forms having the same type.

That is, the information processing apparatus 1 extracts the value of the items from all the forms only by correcting the value of the item of the attribute for any form and extracts the items from all the forms, even though the user does not define the item of the attribute assigned to the form having the same type.

### Modification Example

The exemplary embodiment has been described above, but the content of the exemplary embodiment may be modified as follows. The modification examples as follows may be combined with each other.

1

In the above-described exemplary embodiment, the information processing apparatus 1 includes the processor 11 configured by a CPU, but the control unit that controls the information processing apparatus 1 may have another configuration. For example, the information processing apparatus 1 may have various processors and the like in addition to the CPU.

In the embodiments above, the term “processor” refers to hardware in abroad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

2

In the embodiments above, the term “processor” is broad enough to encompass one processor or plural processors in collaboration which are located physically apart from each other but may work cooperatively.

The order of operations of the processor is not limited to one described in the embodiments above, and may be changed.

3

In the above-described exemplary embodiment, the information processing apparatus 1 may have the function of the terminal 2. In this case, the information processing apparatus 1 may have a configuration corresponding to the operation unit 24 and the display unit 25 in the terminal 2. The image scanning device 4 may have the function of the terminal 2.

4

In the above-described exemplary embodiment, the information processing apparatus 1 does not cause the user to confirm the custom rule generated based on the item value input by the user, but may cause the user to confirm the generated custom rule.

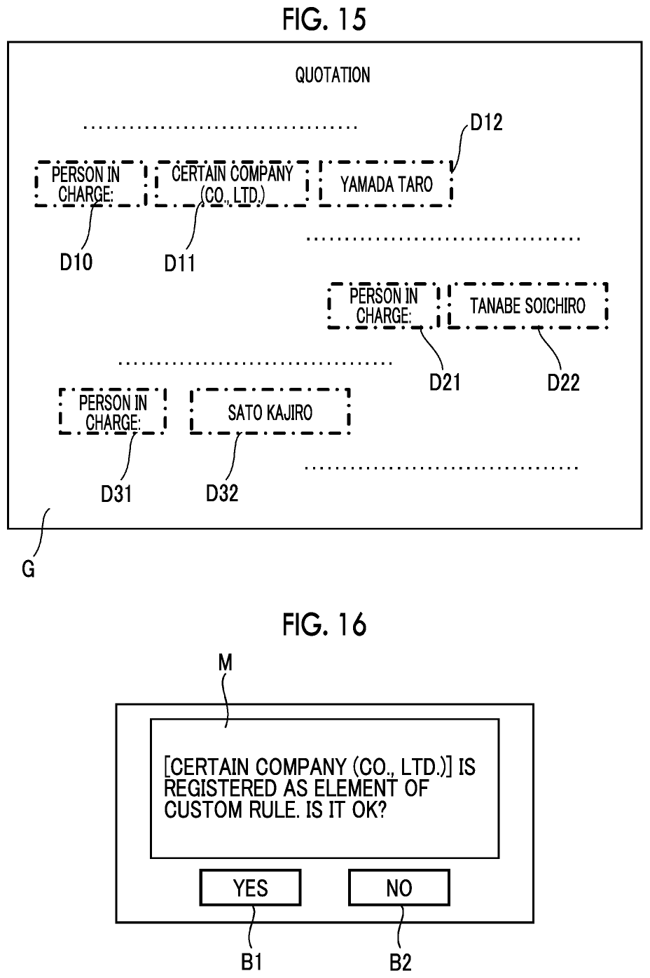

FIG. 15 is a diagram illustrating a situation in which an erroneous custom rule is generated. An image G illustrated in FIG. 15 is a form of a quotation sheet. In a case where the user inputs “Yamada Taro” as the customer person in charge, the information processing apparatus 1 specifies a region D12 in which the text string “Yamada Taro” is described from the image G. The information processing apparatus 1 searches for the element described around the specified region D12.

At this time, the user inputs the item value “Yamada Taro” as the item value corresponding to the attribute name “customer person in charge”. Therefore, what is required of the information processing apparatus 1 is to generate a custom rule using the text string “person in charge:” described in the region D10 illustrated in FIG. 15 as an element.

However, as illustrated in FIG. 15, the region D10 is farther than the region D11 in a case of being viewed from the region D12. Therefore, contrary to the intention of the user, the information processing apparatus 1 specifies the text string “certain company Co., Ltd.” described in the region D11, as the element, and generates the custom rule using the specified text string.

That is, the user inputs only the item value on the correction screen and the information processing apparatus 1 generates the custom rule for extracting the item value. Thus, the custom rule may not meet the intention of the user. Therefore, the information processing apparatus 1 may receive an approval of the user in a case of generating the custom rule.

FIG. 16 is a diagram illustrating a manner of transmitting an inquiry for using the custom rule to the user. In a case where the information processing apparatus receives the input of the item value of the attribute from the user and generates the custom rule based on the item value, the information processing apparatus 1 shows at least a portion of the contents of the custom rule and transmits an inquiry for using the custom rule to the user. For example, the information processing apparatus 1 presents a dialog box illustrated in FIG. 16.

As illustrated in FIG. 16, a message indicating that “[Certain company (Co., Ltd.)] is registered as the element of the custom rule. Is it OK?” is included in the dialog box. Regarding the message, in a case where the user presses a button B1 on which the text string “yes” indicating approval is described, the information processing apparatus 1 registers the above-described custom rule in the custom rule DB 122 of the memory 12. In a case where the user presses a button B2 on which the text string “no” indicating the refusal is described, the information processing apparatus 1 discards the above-described custom rule without registering the custom rule in the memory 12.

Therefore, in this case, the processor 11 of the information processing apparatus 1 is an example of a processor that transmits an inquiry for using the generated rule to the user.

5

In the above-described exemplary embodiment, one item of the attribute assigned to one type of form is associated with one rule (that is, the default rule or the custom rule) for extracting the item value, but a plurality of rules may be associated with the one item. In this case, the information processing apparatus 1 extracts a plurality of different item values for one item by using the plurality of rules. The information processing apparatus 1 may display the plurality of extracted item values in a manner in accordance with the extraction frequency of the rules used to extract the item values.

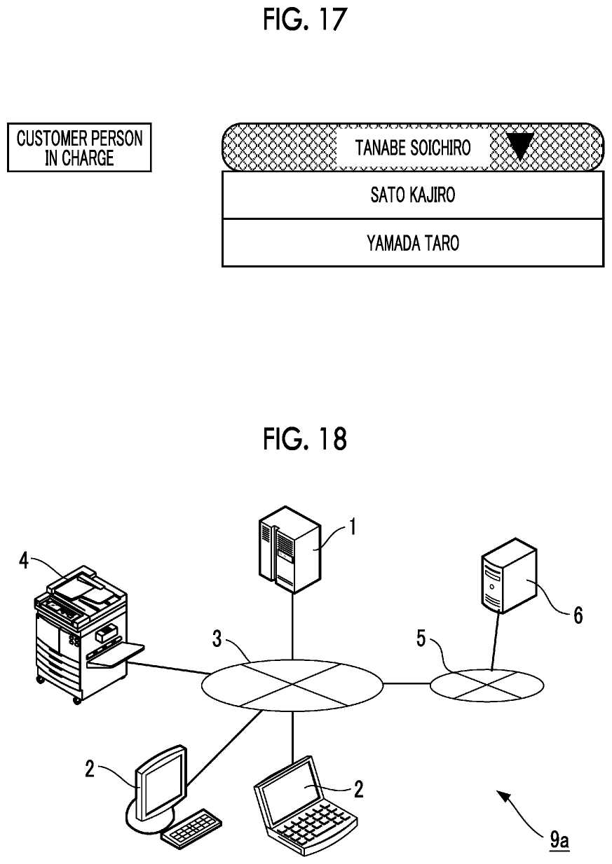

FIG. 17 is a diagram illustrating an example in which a plurality of item values are displayed in a manner in accordance with the extraction frequency of the rule used in extraction. For example, the user inputs a plurality of corrections of the item value corresponding to the attribute name “customer person in charge” among attributes assigned to the form to which the type name “machine and materials department quotation sheet” is designated. As a result, for example, in the information processing apparatus 1, the custom rule IDs “Rc1”, “Rc2”, and “Rc3” are registered as the custom rule IDs for the attribute name “customer person in charge” in the attribute name list 1242 associated with the type name “machine and materials department quotation sheet” in the custom item DB 124.

In this case, the information processing apparatus 1 may refer to the custom rule DB 122 to instruct the terminal 2 to display item values extracted by the identified custom rules in the order of the evaluations associated with the three custom rule IDs.

For example, according to the custom rule DB 122 illustrated in FIG. 4, the frequencies (that is, extraction frequencies) of the three custom rule IDs are “low” for “Rc1”, “high” for “Rc2”, and “middle” for “Rc3”. Therefore, the custom rule IDs are arranged in the order of the extraction frequency, that is, order of “Rc2”>“Rc3”>“Rc1”.

Therefore, the information processing apparatus 1 displays, for example, a so-called pull-down menu in which a plurality of extracted item values are arranged vertically in the order of the extraction frequency of the custom rule used for extracting the item values, and receives the selection of the user.

FIG. 17 illustrates a pull-down menu in which item values extracted by a plurality of rules are arranged in the order of the extraction frequency of the rules. For example, in a case where custom rules identified by the custom rule IDs “Rc1”, “Rc2”, and “Rc3” are used for the image G of the form illustrated in FIG. 15, “Yamada Taro”, “Tanabe Soichiro”, and “Sato Kajiro” are extracted as the item values in this order. The information processing apparatus 1 generates the pull-down menu by arranging the three item values in the order of the extraction frequency of the custom rule used in the extraction. As a result, the pull-down menu in which “Tanabe Soichiro”→“Sato Kajiro”→“Yamada Taro” are arranged from the top to the bottom in this order is displayed.

In a case where the user selects any item value from the pull-down menu, the information processing apparatus 1 sets the selected item value as the item value corresponding to the attribute name “customer person in charge” and stores the item value in the form DB 125. The pull-down menu allows the user to determine and select the certainty of a plurality of item values by evaluation based on the extraction frequency.

Therefore, the processor 11 of the information processing apparatus 1 is an example of a processor that displays the plurality of values of the items in a manner in accordance with the frequency at which the value for the item is extracted by the rules respectively used, in a case where a plurality of rules are provided, and a plurality of values of items are extracted from a second image indicating the form.

In addition, the processor 11 of the information processing apparatus 1 is an example of a processor that receives the approval of the user for the value extracted by using the respective rules for each of the plurality of rules, in a case where the plurality of rules are provided.

6

In the above-described exemplary embodiment, in a case where the user inputs the item value in order to create a new item, the processor 11 functioning as the reception unit 115 receives the input of the corresponding attribute name in addition to the item value. The attribute name indicating the item of the attribute assigned to the form may be acquired by another unit.

For example, the information processing apparatus 1 may acquire the above-described attribute name from an external device. FIG. 18 is a diagram illustrating an example of the information processing apparatus 1 that acquires the attribute name from the external device. An information processing system 9a illustrated in FIG. 18 includes a communication line and a server device 6 in addition to the information processing apparatus 1, the terminal 2, the communication line 3, and the image scanning device 4.

The communication line 5 is a line for communicably connecting the communication line 3 and the server device 6 to each other, and is, for example, the Internet. The server device 6 is a device that provides a service by an application program (simply referred to as an “application” below) to various devices including the information processing apparatus 1 connected to the communication line 3 via the communication line 5.

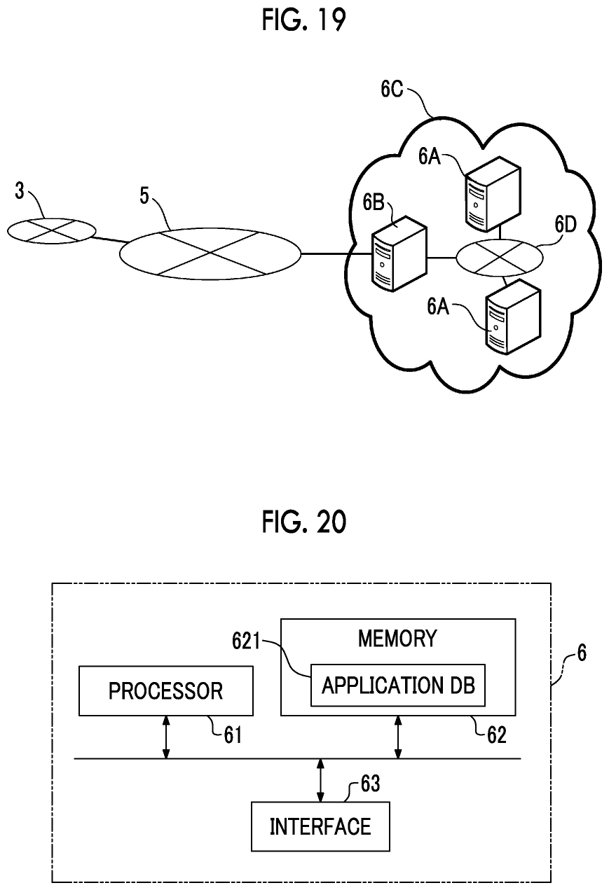

The information processing system 9a may include a cluster system that provides a so-called cloud service instead of the one server device 6 illustrated in FIG. 18. FIG. 19 is a diagram illustrating a cluster system 6C. The cluster system 6C includes a communication line 6D which is a LAN, a plurality of server devices 6A connected by the communication line 6D, and a gateway device 6B that connects the communication line 6D and the communication line 5. The plurality of server devices 6A are devices having the same functions as the above-described server device 6. In this case, the gateway device 6B may monitor the processing statuses of the plurality of server devices 6A and select the server device 6A that provides the service requested by the information processing apparatus 1 via the communication line 5.

FIG. 20 is a diagram illustrating an example of the server device 6. The server device 6 illustrated in FIG. 20 includes a processor 61, a memory 62, and an interface 63. The components are communicably connected to each other, for example by a bus.

The processor 61 reads and executes a program stored in the memory 62, and thereby controls the units of the server device 6. The processor 61 is, for example, a CPU.

The interface 63 is a communication circuit that communicably connects the server device 6 to the information processing apparatus 1, the terminal 2, and the image scanning device 4 via the communication line 3 and the communication line 5 in a wired or wireless manner.

The memory 62 is a storage unit that stores an operating system, various programs, data, and the like read into the processor 61. The memory 62 includes a RAM and a ROM. The memory 62 may include a solid state drive, a hard disk drive, or the like. The memory 62 also stores an application DB 621.

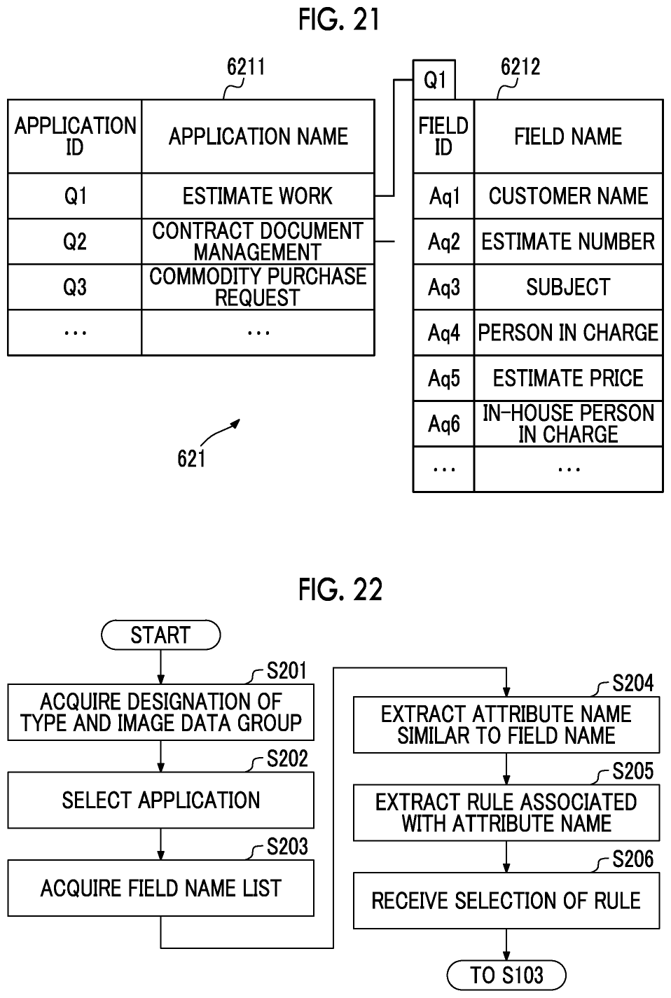

FIG. 21 is a diagram illustrating an example of the application DB 621. The application DB 621 illustrated in FIG. 21 has an application ID list 6211 and a field ID list 6212. The application ID list 6211 is a list in which an application ID is listed in association with an application name being the name of the application. The application ID is identification information of an application that is read and executed by the processor 61 of the server device 6.

The field ID list 6212 is a list associated with each application ID described in the application ID list 6211, and is a list in which pieces of identification information of one or more fields defined by the application identified by the application ID is listed. In the field ID list 6212, a field ID which is identification information of a field, and the field name which is the name of the field are stored in association with each other.

FIG. 22 is a diagram illustrating an example of the operation of the information processing apparatus 1. The processor 11 of the information processing apparatus 1 acquires, by the operation of the user, designation of the type of form and image data group indicating a bundle of scanned forms, from the image scanning device 4 (Step S201). The information processing apparatus 1 acquires a list of the application names from the server device 6, and causes the terminal 2 to display the application names on the terminal 2, and thus a selection screen for causing the user to perform selection is displayed.

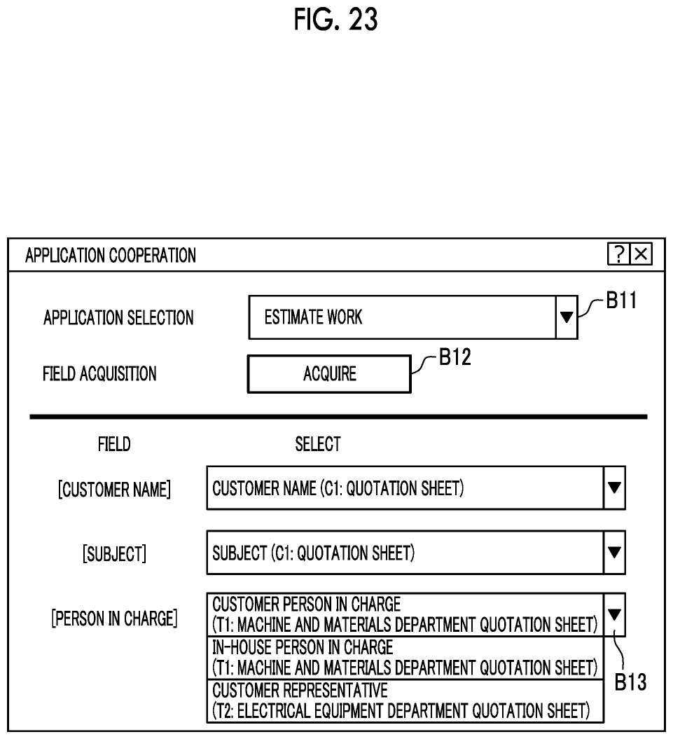

FIG. 23 is a diagram illustrating an example of a selection screen. In the selection screen, a button B11 is a button for selecting one application name from a pull-down menu for displaying a plurality of application names. A button B12 is a button for instructing acquisition of a list of field names defined in the application called by the application name selected by the button B11. In a case where the user selects the application name and issues an instruction to acquire a list of field names, the terminal 2 transmits the instruction to the information processing apparatus 1.

The processor 11 selects an application called by the application name instructed by the user from the terminal 2 (Step S202). The processor 11 transmits the selected application to the server device 6, and acquires the list of field names defined by the application (Step S203).

The processor 11 extracts attribute names similar to the field names included in the acquired list, from the default item DB 123 and the custom item DB 124 (Step S204), and transmits the extracted attribute names to the terminal 2. The processor 11 extracts the default rule or the custom rule associated with the extracted attribute name (Step S205), and causes the terminal 2 to display the selection screen for causing the user to select any of the extracted default rule or custom rule.

At this time, as illustrated in FIG. 23, the terminal 2 displays the field names listed in the list received from the information processing apparatus 1, in the field at the lower left of the selection screen. The terminal 2 displays candidates for the attribute name similar to the field name, on the right side of the field names by a pull-down menu. The user selects the displayed candidates for the attribute name to select the rule associated with the selected attribute name.

In a case where the processor 11 receives the selection of the rule by the user from the terminal 2 (Step S206), the processor 11 causes the process to proceed to Step S103 illustrated in FIG. 11.

In this case, the processor 11 extracts the candidates for the attribute name of the attribute required to be assigned to the form by the field name acquired from the server device 6 and causes the user to perform selection. Thus, the user may not input the attribute name. Further, the field name in the application and the attribute name in the information processing apparatus 1 are associated with each other by the selection screen. Thus, it is possible to apply the result obtained by the information processing apparatus 1 assigning the attribute to the form to the application of the server device 6. That is, the information processing apparatus 1 can cooperate the function of the information processing apparatus with the application executed by the server device 6.

7

In the above-described exemplary embodiment, the program executed by the processor 11 of the information processing apparatus 1 is an example of a program causing a computer including a processor to execute a step of receiving, from a user, an input of the value of the item of the attribute assigned to the form shown by the acquired first image, a step of specifying the region in which the value of the item is shown in the first image, a step of generating the rule for extracting the value of the item by using at least one of the element at a predetermined distance from the specified region or the coordinates of the region in the first image, and a step of extracting the value of the item from the form shown by the acquired second image.

The program may be provided in a state of being stored in a recording medium that can be read by a computer device, such as a magnetic recording medium such as a magnetic tape and a magnetic disk, an optical recording medium such as an optical disk, an optical magnetic recording medium, and a semiconductor memory. The program may be downloaded via a communication line such as the Internet.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
receive an input of a value of an item of an attribute from a user, the attribute being to be assigned to a form shown by an acquired first image;
specify a region in which the value of the item is shown in the first image;
generate a rule for extracting the value of the item by using at least one of an element at a predetermined distance from the specified region or coordinates of the region in the first image; and
extract the value of the item from a form shown by an acquired second image by using the rule.

2. The information processing apparatus according to claim 1, wherein the processor is configured to:
transmit an inquiry for using the generated rule to the user.

3. The information processing apparatus according to claim 2, wherein the processor is configured to:
in a case where a plurality of the rules are provided, and a plurality of the values of the items are extracted from the second image, display the plurality of the values of the items in a manner in accordance with a frequency at which the value for the item is extracted by the rule.

4. The information processing apparatus according to claim 3, wherein the processor is configured to:
in a case where the plurality of the rules are provided, receive an approval of the user for the value extracted by using the rule for each of the plurality of rules.

5. The information processing apparatus according to claim 3, wherein the processor is configured to:
delete the rule in which an extraction frequency of the value of the item is less than a threshold value for a predetermined period.

6. The information processing apparatus according to claim 4, wherein the processor is configured to:
delete the rule in which an extraction frequency of the value of the item is less than a threshold value for a predetermined period.

7. The information processing apparatus according to claim 1, wherein the processor is configured to:
extract the value of the item from the form shown by the second image, for each type of the acquired second image.

8. The information processing apparatus according to claim 2, wherein the processor is configured to:
extract the value of the item from the form shown by the second image, for each type of the acquired second image.

9. The information processing apparatus according to claim 3, wherein the processor is configured to:
extract the value of the item from the form shown by the second image, for each type of the acquired second image.

10. The information processing apparatus according to claim 4, wherein the processor is configured to:
extract the value of the item from the form shown by the second image, for each type of the acquired second image.

11. The information processing apparatus according to claim 5, wherein the processor is configured to:
extract the value of the item from the form shown by the second image, for each type of the acquired second image.

12. The information processing apparatus according to claim 6, wherein the processor is configured to:
extract the value of the item from the form shown by the second image, for each type of the acquired second image.

13. A non-transitory computer readable medium storing a program causing a computer having a processor to execute a process comprising:
receiving an input of a value of an item of an attribute from a user, the attribute being to be assigned to a form shown by an acquired first image;
specifying a region in which the value of the item is shown in the first image;
generating a rule for extracting the value of the item by using at least one of an element at a predetermined distance from the specified region or coordinates of the region in the first image; and
extracting the value of the item from a form shown by an acquired second image by using the rule.

14. An information processing method comprising:
receiving an input of a value of an item of an attribute from a user, the attribute being to be assigned to a form shown by an acquired first image;
specifying a region in which the value of the item is shown in the first image;
generating a rule for extracting the value of the item by using at least one of an element at a predetermined distance from the specified region or coordinates of the region in the first image; and
extracting the value of the item from a form by using the rule, the form being shown by an acquired second image.
